(19) United States
(12) Patent Application Publication
(10) Pub. No.: US 2025/0139184 A1
(43) Pub. Date: May 1, 2025

(54) QUALITY SCORING SYSTEM AND METHOD HAVING SAAS ARCHITECTURE AND SOURCE AND INDUSTRY SCORE FACTORS

(71) Applicant: SEEKR Technologies, Inc., Vienna, VA (US)

(72) Inventors: Stefanos Poulis, Vienna, VA (US); Robin J. Clark, Vienna, VA (US); Patrick C. Condo, Vienna, VA (US)

(73) Assignee: SEEKR Technologies, Inc., Vienna, VA (US)

(21) Appl. No.: 19/004,795

(22) Filed: Dec. 30, 2024

Related U.S. Application Data
(63) Continuation of application No. PCT/US24/37653, filed on Jul. 11, 2024.
Application No. PCT/US24/37653 is a continuation-in-part of application No. 18/582,111, filed on Feb. 20, 2024, now Pat. No. 12,174,903.
Application No. 18/582,111 is a continuation of application No. 18/220,437, filed on Jul. 11, 2023, now Pat. No. 12,210,535.
(63) Continuation-in-part of application No. 18/392,402, filed on Dec. 21, 2023, now Pat. No. 12,254,872.
Application No. 18/392,402 is a continuation of application No. 18/243,588, filed on Sep. 7, 2023, now Pat. No. 11,893,981.

(51) Int. Cl. G06F 16/9538; G06F 16/215; G06F 16/2457; G06F 16/951; G06F 16/9535

(52) U.S. Cl. CPC G06F 16/9538; G06F 16/215; G06F 16/24578; G06F 16/951; G06F 16/9535

(57) ABSTRACT

A quality score system and method for a piece of content. The system and method may use artificial intelligence/machine learning to determine the one or more scores for each piece of content. In one embodiment, the quality scoring system and method may use a SAAS architecture, may incorporate source and industry score factors and use a transformer model to generate the quality score.

### PRIORITY CLAIMS/RELATED APPLICATIONS

This application is a continuation and claims priority under 35 USC 119 and 120 to PCT Patent Application US2024/37653 filed Jul. 11, 2024 that is in turn a continuation in part and claims priority under 35 USC 120 to U.S. patent application Ser. No. 18/582,111 filed Feb. 20, 2024 (now U.S. Pat. No. 12,174,903 issued on Dec. 24, 2024) that in turn is a continuation of and claims priority under 35 USC 120 to U.S. patent application Ser. No. 18/220,437 filed Jul. 11, 2023. This application is also a continuation in part and claims priority under 35 USC 120 to U.S. patent application Ser. No. 18/392,402 filed on Dec. 21, 2023 that in turn is a continuation of and claims priority under 35 USC 120 to U.S. patent application Ser. No. 18/243,588 filed on Sep. 7, 2023 (now U.S. Pat. No. 11,893,981 issued on Feb. 6, 2024). The entirety of all of the above are incorporated herein by reference.

### APPENDIX

Appendix A (4 Pages) contains more details of the GARM standards that may be used in the quality scoring system. Appendix A forms part of the specification and is incorporated herein by reference.

### FIELD

The disclosure relates to search systems and method that receive a query and return search results with quality scores.

### BACKGROUND

A search engine is part of everyday life in which a user searches for information about a topic, a product and the like. The Google® search website is the most well known search engine. However, most search engines adjust search results that may be returned to the user in ways that may not be apparent to the user. For example, a user would reasonable expect that the best search results would appear at the top of the search results page. However, that is not the case due to sponsored advertisements and the like. For example, the Google® search results may have one or more sponsored web-sites/ads at the top of each search results page based on the query terms of the search. These may or may not be the most relevant results based on the initial query.

Most search engines return results based on an algorithm that parses the query terms and returns results based on those query terms. Most search engines do not perform any quality check on the search results and expect a user to assess the quality of the story/article, etc. especially for stories, articles, etc. about hot topics. The quality of the reporting may be influenced by persuasive techniques so that the reader is guided towards a particular point of view of the author of the story, contradictions in the story that evidence inconsistencies in the story and clickbait techniques that are solely intended to get the reader to click on a link to something else. For most search engines, the reader may be totally unaware of the poor quality of the story and in fact think that it is of high quality. It is desirable to be able to assess the quality of each story for the reader and provide an assessment of the article quality to the reader when the search results are returned to the user.

In addition to the story quality, most stories and articles returned in search results today are written with a bias or written from a particular political perspective. For example, most articles written about former president Donald Trump are written by authors aligned with Donald Trump and authors who despise Donald Trump. Even articles that are not political or about a political issue may be written with a political slant/lean. It is often difficult for a reader to determine the political lean of each article without reading through the article. Thus, like the quality of the story, it is desirable to be able to assess the political lean of each story for the reader and provide an assessment of the political lean of each story to the reader when the search results are returned to the user.

Thus, it is desirable to provide a search engine system that uses technology and provides a technical solution and provides an assessment of the quality of the story and an assessment of the political lean of the story that are provided to the user with the search results and it is to this end that the disclosure is directed.

### BRIEF DESCRIPTION OF THE DRAWINGS

FIG. 1 is a block diagram of a search system that provides a quality assessment and political lean assessment for each piece of content returned as search results;

FIG. 2 illustrates a method for providing search results with quality and/or political lean scores;

FIG. 3 illustrates more details of the search engine backend shown in FIG. 1;

FIG. 4 illustrates an example landing page search user interface that includes a quality score;

FIG. 5 illustrates an example of a news user interface showing pieces of content with a quality score;

FIG. 6 illustrates an example of a detailed score user interface;

FIG. 7 illustrates an example of a politics search results with quality and political lean scores;

FIG. 8 illustrates an example of a detailed score user interface for both a quality score and political lean score;

FIG. 9 illustrates an example of the scores for a Reuters article by the different ML models for each journalistic principle;

FIG. 10 illustrates an overall quality scoring method for the system;

FIG. 11 is an example of a score user interface for a first piece of content with breaking news without a byline;

FIG. 12 is an example of a score user interface for a second piece of content with breaking news without a byline;

FIG. 13 is an example of a score user interface for a third piece of content with breaking news without a byline;

FIG. 14 is an example of a score user interface for a first piece of content with ad hominem opinions;

FIG. 15 is an example of a score user interface for a second piece of content with ad hominem opinions;

FIG. 16 is an example of a score user interface for a third piece of content with ad hominem opinions;

FIG. 17 is an example of a score user interface for a first piece of content with a subjective opinion;

FIG. 18 is an example of a score user interface for a second piece of content with a subjective opinion;

FIG. 19 is an example of a score user interface for a third piece of content with a subjective opinion;

FIG. 20 is an example of a score user interface for a first piece of content with source attribution; and

FIG. 21 is an example of a score user interface for a second piece of content with source attribution.

### DETAILED DESCRIPTION OF ONE OR MORE EMBODIMENTS

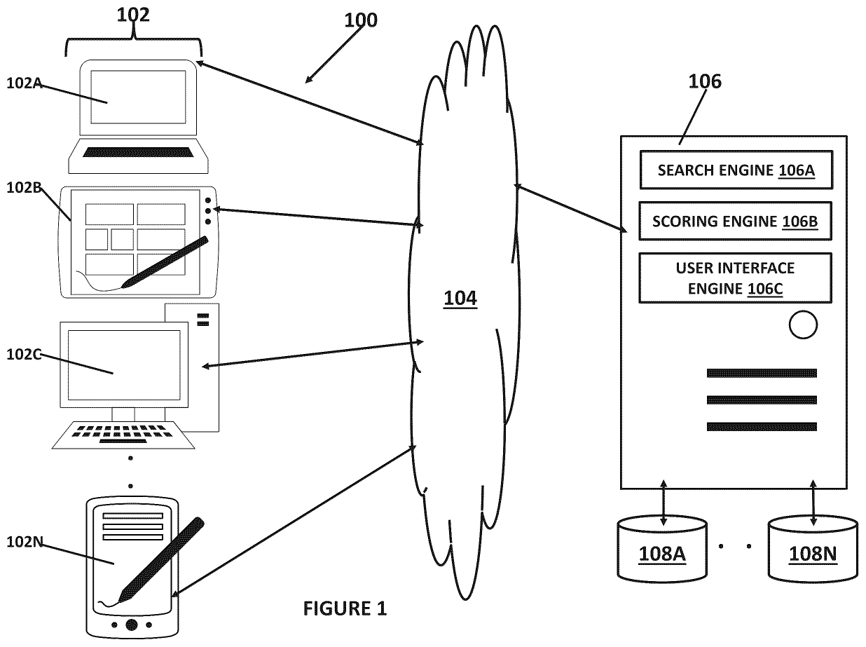

The disclosure is particularly applicable to a consumer facing search engine that generates a quality assessment and political lean assessment using machine learning techniques for each piece of content returned in search results to a consumer in which each user accesses/communicates with a search engine backend over the Internet and results are returned to each user in a client/server architecture and it is in this context that the disclosure will be described. The political lean score for a piece of content may be indicative of a political bias of the piece of content based on its substance and how it is written. The quality score for each piece of content scores each piece of content against a plurality of factors that assess the quality of the piece of content. It will be appreciated, however, that the search system and method may be implemented using different computer architectures such as a software as a service (SAAS) architecture or other known or yet to be developed computer system architectures. Furthermore, the search system and method may be a standalone system accessed over the web by users as shown in FIG. 1, but may also be embedded/part of a larger system. The search system and method may be used to search any type of content and return results although, for illustration purposes, article/news story results (collectively articles) will be discussed to illustrate the quality assessment and political lean assessment. It should also be noted that the search engine results in response to a query may include results that have the quality and political lean assessments as well as results that do not have those assessments.

The search engine system and method disclosed below may have various technical features including the news article quality scoring (to generate the quality assessment), political lean detection (to generate the political lean assessment), large scale document scoring, AI-based quality scoring, explainable AI, AI-based assessment of adherence to journalistic principles, fake news detection, political bias detection and multi-modal (text-image) learning. These technical features provide a technical solution to a technical problem that cannot be achieved by a human being.

The search system and method provides many technical solutions and benefits over known conventional search systems and these benefits are not achievable by a human being and require technology. The benefits include accuracy improvements over benchmark open-source datasets for most scoring detectors and accuracy for all detectors has increased over time by utilizing richer datasets, more domain experts and several data augmentation techniques. Furthermore, the latency of the. system has decreased tremendously since its inception after improvements in system architecture and new hardware addition. The system also guides usage of search results (news and web), can educate users about potential issues behind search results they consume and allow the user to have a holistic view of search results in understanding the quality and/or political lean. The system allows users to select and view articles of low, medium, high quality, left, center, right political leaning. The system also may organize/rank/filter results depending on user's needs (by score, by lean, by topic).

FIG. 1 is a block diagram of a search system 100 that provides a quality assessment and political lean assessment for each piece of content returned as search results using technical solutions that achieve the benefits for users set forth above. Like other known search engines, a user may use a computing device 102 to connect to, communicate with and access a search system 106 over a communications path 104 in order to perform a keyword search or browse certain categories of searches. Thus, the user connects to and communicates with the search system 106 (to convey the keywords or category), the search system 106 performs the search and/or returns search results in the form of links to pieces of content in which each piece of content may include a quality score and/or a political lean score that are generated by the search system 106 for a keyword search (or pre-generated if the user selects a category of results) and returned to the user in a user interface that includes links to each piece of content and the quality score and/or the political lean score. The quality score and/or the political lean score are generated in the same manner for both the keyword search and the pre-assigned categories of search results as described below in more detail.

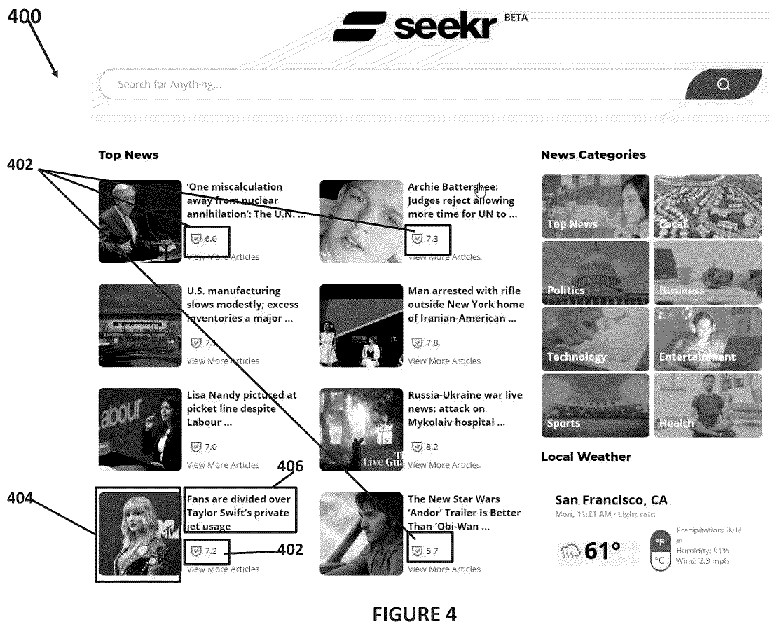

The system 100 may have a plurality of computing devices 102A, 102B, 102C . . . , 102N that can each independently access the search system 106 over the communications path 104. Each computing device may have a processor, memory, wireless or wired connectivity circuits to connect to the search system 106 and a display wherein the memory stores a known browser application, such as Google® Chrome®, etc., that is a plurality of lines of instructions executed by the processor that allows the user to interact with the search system 106. The search system 106 may send back HTML pages with the search results that are converted into a user interface by the browser and displayed on the display of the computing device (examples of the user interface are shown in FIGS. 4-8.) As shown in FIG. 1, each computing device 102 may be a laptop computer 102A. a tablet computer 102B, a personal computer 102D, a smartphone device 102N or any other device that is capable of connecting to and communicating with the search system 106. The communications path 104 may a wireless and/or wired path that may be secure or unsecure.

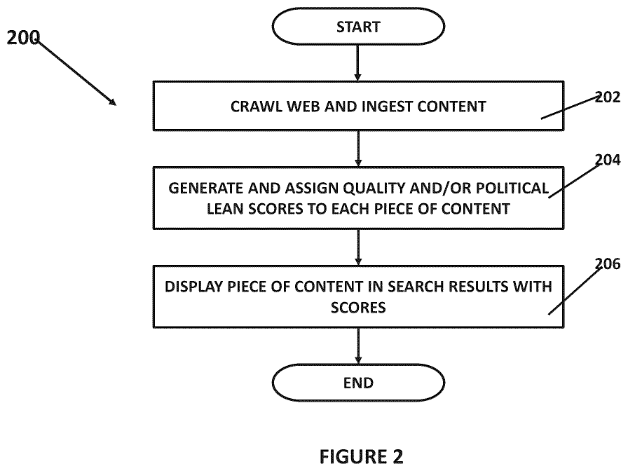

The search system 106 may be implemented by one or more computing resources, such as server computers, blade servers, cloud computing resources, etc. that have at least one processor and memory that store and execute a plurality of lines of instructions/computer code to perform the search and scoring operations of the search system 106. The search system may further have a search engine 106A, a scoring engine 106B and a user interface engine 106C, each of which may be a plurality of lines of instructions/computer code executed by the processor. The search engine 106A may perform the search engine operations to parse a keyword query, perform the search and return the one or more pieces of content that form the search results in a well-known manner. The scoring engine 106B may perform a quality rating and/or political lean scoring process to generate either/both of the quality score and the political lean score that are discussed below in more detail with reference to FIG. 2. The user interface engine 106C collects the search results or categories and the quality score and/or political lean score and send those back to each computing device is response to the request from each computing device in a well-known manner. The search system 106 may have one or more hardware or software storage 108A, . . . , 108N that store the data used for the searches including the software for the various engines, user data, data used to perform the quality and/or political lean assessments.

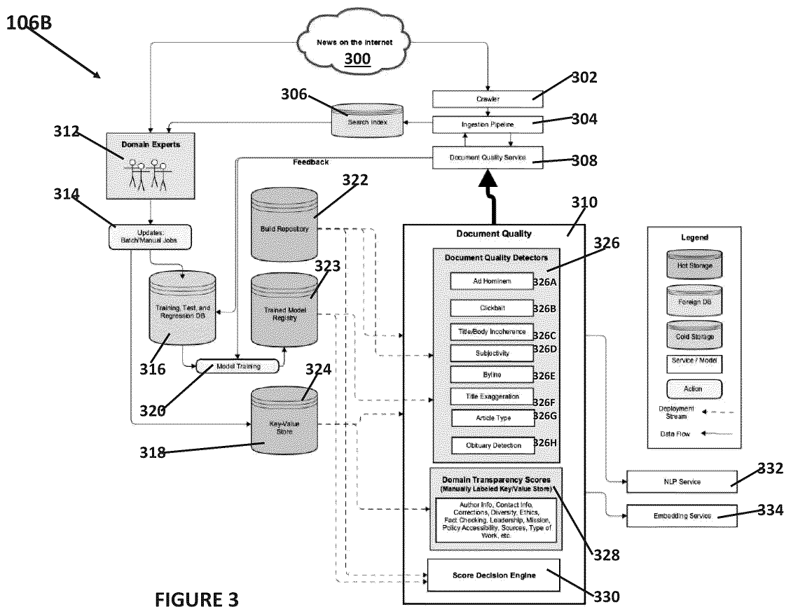

FIG. 2 illustrates a method 200 for providing search results with quality and/or political lean scores. The method 200 may be performed by the system in FIG. 1, but may also be performed using other systems and hardware that can perform the processes. In the method, a search engine/search system may crawl the web (202) and ingest the various pieces of content that may include web pages, articles, PDF files, word documents and/or any other type of content. In one embodiment, each piece of content may be a piece of news. The method, for each piece of ingested content, may generate and assign a quality score and/or a political lean score (204). In one embodiment, this process 204 may be performed by the scoring engine 106B in FIG. 1. In addition, if a new piece of content or a piece of content that has not been ingested already is a result of a search query, the method may perform on the fly scoring of the piece of content using the same scoring methodology that will be discussed below in more detail with reference to FIG. 3. Then, the method, in response to the search query may display search results (or categories of results) wherein each search result has a squib (image and summary of piece of content) along with one or more scores (206) wherein the scores may be a quality score and/or a political lean score. Examples of these displayed results are shown in FIGS. 4-8 discussed below in more detail.

FIG. 3 illustrates more details of the search engine backend and in particular the scoring engine 106B shown in FIG. 1. The scoring engine 106B may gather pieces of content, such as news pieces of content, from a corpus 300, such as the Internet with the objective to be able to assess the quality and/or political lean of each piece of content in a programmatic manner. The objective is achieved by technical solutions discussed below that include document quality detectors 326 broken down as a set of journalistic principles, each solved individually, detecting political bias of the article, using domain expertise (trained data journalist(s)) to teach the system how to score the pieces of content and then use principles from machine teaching, where experts interact with the model, correct its mistakes, iterate so that the machine learning model(s) used to score the pieces of content learns and becomes better at accurate scoring each piece of content. The scoring engine 106B may use explainable artificial intelligence (AI) that uses novel techniques to explain the system's prediction to the teacher, to allow for easy corrections and bias detection. The scoring engine 106B may be trained on carefully designed datasets, build in-house, using aforementioned expertise.

The scoring engine 106B and models therein are designed to emulate the process of a highly trained journalist. The models may be trained on proprietary datasets curated by expert journalists and linguists and utilize vector representations yielded by language models. In one implementation, the one or more models may be transformer-based architectures and recurrent long-short term memory neural networks that utilize custom attention mechanisms. Attention mechanisms are used to carefully compare the title with the content of the article and detect violations of journalistic principles like clickbait, subjectivity, ad hominem, attacks, quality and type of the sources cited in the article, just as a human expert would do. The one or more models may use different extractive summarization algorithms to enable assessing the degree of relevance of detected violations to the main content of the article and inform the scoring. The one or more models may use a stance detection algorithms to evaluate the stance towards an individual or a topic. Some models may be applied at the sentence level, where a vector representation of each sentence is passed through a neural network model that produces a probability of a violation for that sentence. The sentence level score are collected over all sentences and use different known aggregation algorithms to produce a score over the whole article.

The degree of violation of each journalistic principle is used to give a quality score to each article. In one implementation, the final overall scoring model may be a tree-ensemble architecture trained on set of teaching scenarios curated by journalists. The tree-model has learned from the teaching scenarios to adapt to the non-linear dependencies that may exist in news content. For example, subjectivity is expected in certain article types like Op-eds. On the other hand, subjectivity should be penalized heavily in breaking news articles that are straight reporting.

In another implementation, the overall score model may be a transformer-based neural network that has been trained to follow step-by-step, chain-of-thought process, that takes into account several factors, such as the article category and type, degree of violation of each journalistic principles etc.—just as how a journalist thinks when assessing the quality of an article.

The pieces of content in the corpus 300 may be gathered using a well-known crawler 302 that feeds the pieces of content into an ingestion pipeline 304. The ingestion pipeline 304 may be based on a pub sub flow, wherein articles flow from on step to the next. The ingestion pipeline 304 is designed to auto scale to be able to cope with the incoming load and backpressure. The ingestion pipeline 304 also may feed the pieces of content to a search index 306 that stores them. The ingestion pipeline 304 may also feed the pieces of content to a document quality service engine 308 that also returns the scored pieces of content to the ingestion pipeline 304 so that the scored pieces of content may be stored in the search index database 306. Each piece of content may be scored by a document quality engine 310 as discussed below.

The scoring engine 106B may use one or more domain experts 312 to train the ML and AI processes based on the corpus 300 and the search index 306. In addition, sampling techniques using known active learning algorithms may be used to sample informative data points to annotate. For example, the domain experts 312 may manually review some pieces of content that the active learning algorithm finds to be informative and useful for the learning machine and score them for either/both quality or political lean (314) and store them in a training, test and regression database 316. Then a model training pipeline (316) is activated to produce a model that is stored in a model registry (323). Automatic or manual batch jobs can then be activated (314) to test the models against a training, test DB and track regressions on previously annotated samples. Model configurations and parameters are stored into a key-value store 324. These parameters and configurations are fetched when models are deployed in production and begin scoring live documents that have not been seen during training. The training data in the training database 316 may be used for model training 320 along with any feedback from the document quality service 308. The feedback may also be input to the training database 316.

The feedback to models may include fully annotated samples, words, expressions or features (feature feedback) that the models will learn from. Specific known feedback algorithms are employed to force the models focus on the semantic dimensions that are important. The feedback may also be model-mistake specific, wherein the expert may provide feedback on a specific mistake to correct the models' prediction. The feedback may also be in the form of a labeling function, wherein the teacher may supply a rule to weakly label data points in bulk. The expert may also be able to look at the models gradient vector and further establish areas where the models need further training.

The trained models may be stored in a trained model registry 323. The trained models are then used to perform the scoring processes. In one implementation, the system uses several machine learning models, one for each task and the output of each model is combined using a known meta-learning machine learning model with a model that maps all the outputs into a single total quality score. The meta-learning model has been trained to follow a chain-of-thought process of a journalist and has learned to take into consideration nuanced combinations of scorers, articles types and article categories as set forth below in the different scenarios. For example, the meta-learning model may reduce the influence of a byline subscore for a breaking news article as discussed in the examples below. As shown in FIG. 3, the scoring engine 106B also may have a build repository 322 that stores the data and code/instructions that are used to train and build the models used by the system including the meta-learning machine learning model.

The scoring engine 106B, using the trained model(s) may be used in document quality detectors 326 to determine the quality score of each piece of content based on a number of different metrics. In one implementation, the system may include different machine learning (ML) algorithms for detecting violations of different journalistic principles. For example, the document quality detectors 326 may include an Ad Hominem detector 326A that detects a piece of content directed to an attack on a person instead of the positions of that person, a clickbait detector 326B that detects whether the title of the piece of content appeals to curiosity or emotion instead of describing the story, a Title/Body Incoherence detector 326C that detects a degree of incoherence between the article's title and the article's body (e.g., that the body is directed to a particular subject while the title might be written to be clickbait), a subjectivity detector 326D that detects that the piece of content expresses points of view that go beyond reporting facts, a byline detector 326E that detects if the piece of content has a byline naming the author(s) or not, a title exaggeration detector 326F that detects if the title of the piece of content overstates aspects of the piece of content, an article type detector 326G that detects the type of the piece of content, such as news, opinion, etc., an obituary detector 326H that detects if the piece of content is an obituary and a source attribution detector (not shown in FIG. 3) that evaluates the quality of the sources (on record, off record, background) within the article. The detectors may also detect if the piece of content is s personal attack piece of content in which a person is attacked rather than arguments presented and detect lack of site disclosure for the website that published the piece of content since website that do not share their mission, ownership and policies may be less reliable. In addition to the detectors shown, the document quality 310 may also assess the political leaning of a piece of content wherein the piece of content may have no political lean, right lean, left lean or center lean as determined by a training model that is able to differentiate/classify the different political leanings of the piece of content. Each of these detectors in FIG. 3 may generate a score factor that may be aggregated to generate a total quality score for each piece of content.

The scoring engine 106B may have additional scorers/score detectors that generate additional quality score factors that may be aggregated into the total quality score for the piece of content as described above. As above, each of these additional scorers may be a machine learning system/model that is able to perform the detection and scoring associated with each of these additional scorers. For example, the scoring engine 106B may have a source attribution scorer that may determine the source of each piece of content (author, publisher, etc. depending on the piece of content) and then determine the quality of the determined source. The source attribution scorer may determine the quality of the determined source based on public or private data. For example, an individual that posts an article (the piece of content) on a website that does not vet the article (and that does not otherwise have other data sources that verify the quality of that individual) would have a low quality score (1 out of 10 for example). Similarly, a post to a website (Reddit, Facebook, etc.) by the same individual would similarly receive a low source attribution quality score factor. As another example, a well respected professor at a well respected university known to publish good quality articles would have each article (the piece of content) rated a higher source attribution factor, such as 7 out of 10. This source attribution factor may be then aggregated into the total quality score for the piece of content.

### Source Quality Factor

An additional scorer may be a source quality scorer that assesses the quality of the citations and sources of information in the piece of content/article. For example, a well-sourced, well-written article must cite reputable and named sources

A named source may be a best possible type of sourcing and the source of this kind typically has a name, and if it refers to a person, it usually has a title. Alternatively, it may denote an organization or entity such as the White House or FBI. For example, “According to John Smith, CEO of ABC Corporation, ‘Our company is committed to sustainability and reducing our carbon footprint’” is an example of a named source and would thus have a higher quality source factor score.

A titled source may be a second best type of sourcing and how the overall piece of content/article score will be scored/penalized will depend on the overall context. Sources of this nature are typically referred to by a title rather than a name and journalists make an effort to provide as much description as possible about the anonymous source. For example, ““senior military officers with direct knowledge of the program” or “former Defense Intelligence Agency officers” who were willing to talk only on the condition that they not be identified” or ““According to a senior White House official familiar with the matter, the administration is considering a range of options to address the issue” are examples of the titled source.

The least preferable type of sourcing (resulting in a lowest source quality score factor) may be an anonymous source. The anonymous source is also the least preferable type of sourcing from a journalist's point-of-view. These are sources that do not have a name or title and, if they contain any additional information at all, it is generally very vague. Examples of anonymous sources may be “experts say”, “people familiar with the matter”, “an anonymous source” or “a source who requested anonymity.”

### Industry Standard Quality Factors

The scoring engine 106B also may have a quality score factor that is based on an industry standard. For example, the scoring engine 106B may have a Global Alliance for Responsible Media (“GARM”) standards and principles scoring detector. Further details of the GARM standards may be found in Appendix A that forms part of this specification. The GARM principles may be used to assess the quality of news articles and attributed quotes and thus may be used to detect bias and stance in the piece of content. The GARM detector, based on the GARM principles (detailed in Appendix A) may generate a GARM score factor (between 1 for low compliance with the GARM standards to 10) based on the GARM standards which may be then aggregated with the other quality score factors.

### Article Type Detectors

The scoring engine 106B also may have an article type detector that determine a type of the piece of content (breaking news, opinion, etc.) and then generates an article type score factor for the piece of content. For example, a piece of content may be detected to be an opinion piece of content by the detector and may be assigned a lower score (1-3) as compared to a piece of content detected to be a breaking news article that is assigned a higher score (6-10) since the breaking news article has higher quality (more accurate and less opinion) than the opinion piece.

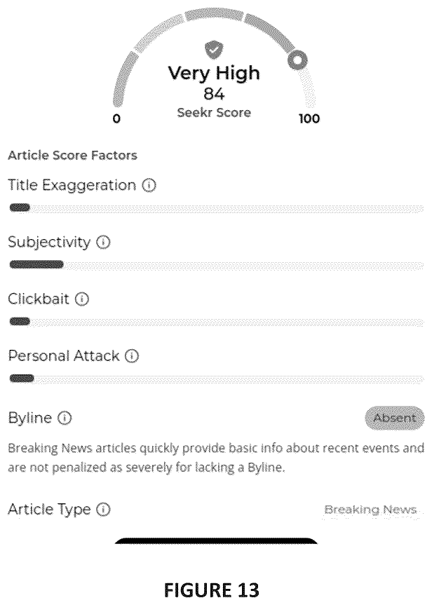

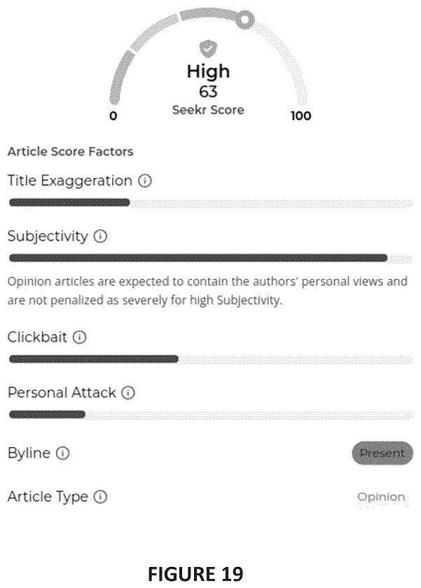

Each of the above scorers may be wholly or partially based on principle alignment methods and techniques that are disclosed in detail in U.S. patent application Ser. No. 18/392,402 and U.S. Pat. No. 11,893,981 that are both incorporated herein by reference. The scoring based on principle alignment methods and techniques is unique to known content scoring systems. Specifically, the scoring based on principle alignment methods and techniques permits each detector/scorer to handle nuanced situations that would not be handled correctly by known systems. For example, the disclosed quality scoring system is able to understand that certain situations may exist that do not affect the overall quality of the piece of content, such as the journalistic quality in one example. As an example, the situation may be that subjectivity is expected in clearly labeled opinion piece so that the overall article quality score should not be affected as much based on the fact that the piece of content is an opinion piece and similarly a breaking news articles may sometimes lack a byline if the story is evolving (a lack of a byline may ordinarily result in a lower byline detector score) but the overall quality score is not affected. In each case above, the subscores (e.g. subjectivity, byline) are not adjusted (e.g., if no byline than low byline subscore), but the overall quality score for the particular piece of content is adjusted. In particular, the model assessing that piece of content triggers an AI-based explanation, as shown in FIG. 19 (i.e. “Opinion pieces are expected to contain the authors' personal views and are not penalized as severely for high Subjectivity”). Similarly, in FIG. 13, the triggered explanation is “Breaking News article quickly provide basic information about events and are not penalized as severely for lacking a Byline”) A known piece of content scoring technique would be unable to adjust the overall quality scoring nor provide the AI-based explanation to the user as shown in the examples. The above process may be a chain-of-thought process that a journalist uses and may be performed, in one embodiment, by the discloses meta-learning machine learning method.

The scoring engine 106B may also include a domain transparency score engine 328 that assesses the information about the source/website of each piece of content including author info, diversity, ethics, leadership, policy accessibility, etc. as shown in FIG. 3 to assess a level of site disclosure of the source of each piece of content that is one of the scores that is part of the overall quality score. The scoring engine 106B may also include a score decision engine 330 that receives all of the scores from the detectors 326 and domain transparency scoring 328 and generates an overall quality score as is shown in the user interfaces shown in FIGS. 4-8. The ML algorithm/model that is used to generate the score is a tree-based ensemble that is trained on carefully curated set of teaching scenarios.

The scoring engine 106B may also include a natural language processing service 332 and a embedding service 334 that receive the output from the document quality engine 310. Thus, using trained ML models, the scoring engine 106B crawls the Internet, gathers pieces of content and generates a quality score and a political lean score for each piece of content all of which is then stored in the search index 306 to be retrieved when a search result for a query matches to the piece of content. The query parsing and matching process is known and operates in a typical manner. In some embodiments, the system may provide its scored pieces of content to third party search engines.

### Overall Scoring

The overall score generated by the system is determined by considering the degree of violation of the above described scoring factors, otherwise known as subscores. In one embodiment, the subscores are based on journalistic principles and include:
Ad hominem/Personal Attack
Byline
Clickbait
Subjectivity
Title Exaggeration
Article Type (e.g. Opinion, Analysis, Breaking News, Beat Reporting, Advertorial, Interview)
Category/Topic (e.g. Politics, Sports etc.)
Source attribution or Unattributed sources

For the overall scoring, each piece of content may have one or more of the above score factors that influence of the quality score for the piece of content. In addition, the particular combination of factors that contribute to the score of a first piece of content may be different from the particular combination of factors that contribute to the score of a second piece of content. Furthermore, different combinations of subscores, article types, and topics may have different effects on the overall score of a piece of content/document. Below are a few examples of how these combinations may affect the document score:

Example 1—Articles about Russia-Ukraine war without a byline-Following the beginning of the war in Ukraine, some news organizations made the decision to remove bylines from related coverage to protect their staff. Since these measures are undertaken to protect journalists rather than deceive audiences, the quality scoring system and method does not penalize articles under this topic for lack of a byline in the byline scoring factor.

Example 2—Opinion articles containing subjectivity-Opinion pieces are subjective by nature, so the quality scoring system and method will not penalize these pieces of content for displaying subjectivity under the subjectivity score factor.

Example 3—Ad hominem/personal attacks in interviews-Interview transcripts or articles describing an interview may contain personal attacks, depending on the topic of the interview and interviewee opinions. Thus, the quality scoring system and method does not treat personal attacks in interviews the same as on other news documents. For example, the personal attack score for the interview piece of content may be higher than for the personal attack score for other news documents showing that the personal attacks are expected in the interview and thus not penalized as compared to the other news documents.

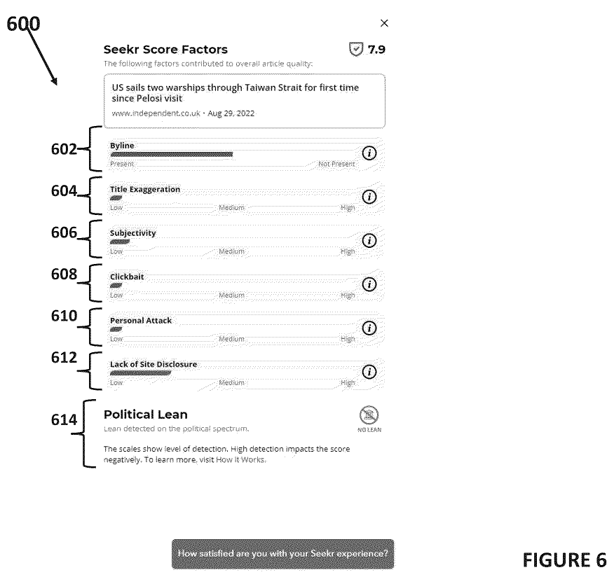

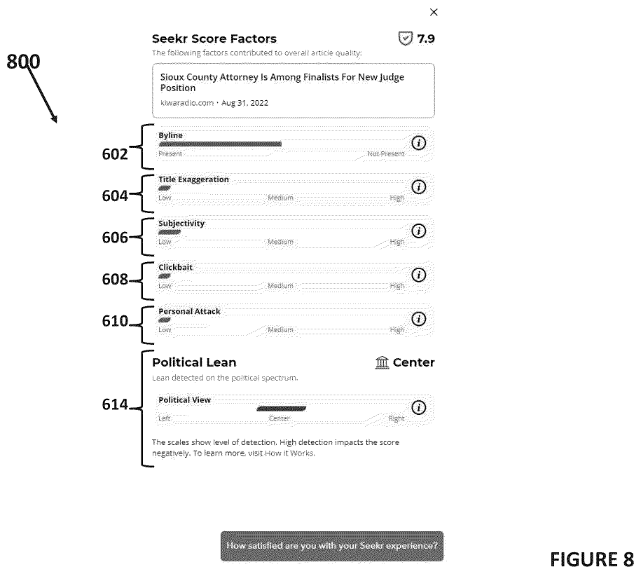

FIG. 4 illustrates an example landing page search user interface 400 that includes a quality score. The landing page is similar to other known search engines that may provide a search bar and a set of categories that the user may select for particular categories of pieces of content. In this example shown, the user interface is for news type pieces of content. For each piece of content, the user interface may have a score 402 (just a quality score in this example, although the search user interface may also display just a political leaning score for political news or both the quality score and political leaning score for other pieces of content) associated with each piece of content. Each piece of content may have a squib that may include a thumbnail image 404 for the particular piece of content, a short summary 406 of the piece of content and the score 402. This user interface allows the user to quickly assess the quality of each piece of content with a higher numerical score indicating a better quality piece of content while a lower numerical score indicating a relatively worse quality piece of content. In each user interface shown in FIGS. 4-5 and 7, a user may click on the score for a piece of content and a detailed summary of the score (examples of which are shown in FIGS. 6 and 8) and its factors are shown to the user.

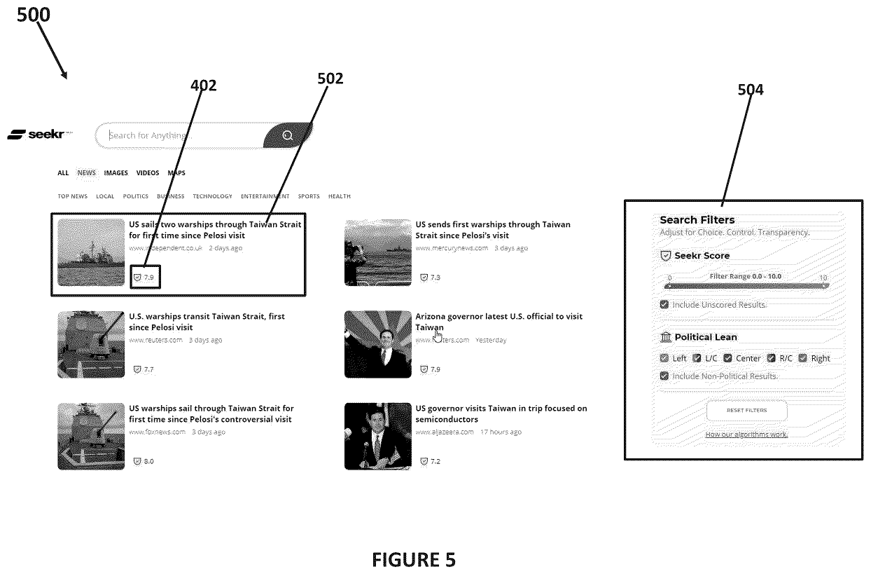

FIG. 5 illustrates an example of a news user interface 500 showing pieces of content with the quality score 402. As in the previous user interface, each piece of content has a squib 502 that shows a brief summary of each piece of content including the score. Each user interface also may have a search filter portion 504 so the user may adjust the pieces of content returned to the user. For example, the user can adjust the desired level of quality score returned using a slider bar and/or request that unscored results are returned in the search results. In the system, only articles that are detected as obituaries and have very little to no content will be unscored. The user may also request pieces of content with a particular political lean and/or non-political pieces of content such as was shown in FIG. 4.

FIG. 6 illustrates an example of a detailed score user interface 600 that shows the details of the score associated with a particular piece of content and the score factors as determined by the document quality engine 310 in FIG. 3. The user interface 600 may score the score of the piece of content and a summary of the piece of content and then the scoring factors including, for example, a byline factor 602 (a score factor indicating whether or not the piece of content names one or more authors since a piece of content without an author has less quality with a score between present or not present) and a title exaggeration factor 604 indicating whether the title overstates aspects of the story with the factor score being low, medium or high. The scoring factors also may include a subjectivity factor 606 that assesses whether the piece of content expresses points of view that go beyond the reporting facts with the factor score being low, medium or high and a clickbait factor 608 that assesses whether the title of the piece of content appeals to curiosity or emotion instead of describing the story with the factor score being low, medium or high. The scoring factors also may include a personal attack factor 610 that assesses whether a person is being attacked rather than the argument with the factor score being low, medium or high and a lack of site disclosure factor 612 that assesses whether the source of the piece of content shares mission, ownership and politics with the factor score being low, medium or high. Finally, a political lean score 614 is shown that detects lean on the political spectrum with no political lean for this piece of content as reflected by the fact that the user interface does not show a political lean score. As noted in the user interface, a higher factor score impacts the score negatively resulting in a lower quality score.

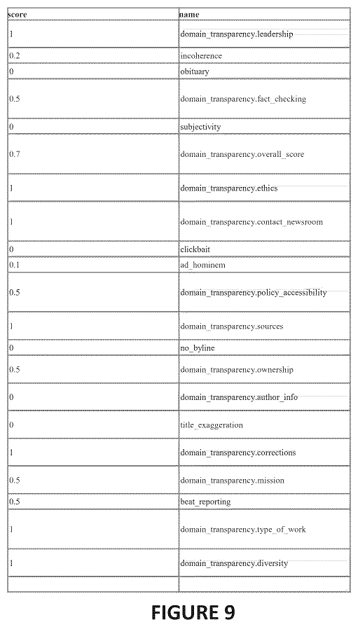

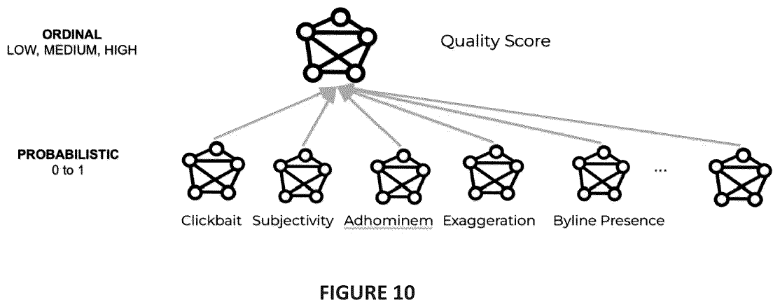

For the scoring process for each article, the article may be first pre-processed and vectorized to identify the parts of the article. For this example, the article may be found at www.reuters.com/world/us/texas-town-struck-by-least-one-tornado-local-media-says-2023-06-16/ which is incorporated herein by reference. Each article may then go through each of the neural network detector models as shown in FIG. 10. Examples of the different neural network detector models for the different journalistic principles may include “clickbait”, “subjectivity”, “adhominem”, “Exaggeration”, “Byline presence”, etc. as shown in FIG. 10 or all of the models shown in FIG. 9. Each model will produce a confidence score between 0 and 1 that corresponds to the degree that each principle was violated. An example of the scoring by each journalistic principle model is shown in FIG. 9. The scores for each journalistic principle model, along with other information, like the topic of the article and the type of the article will be fed into another model (meta learning model discussed above) to produce the quality score as shown in FIG. 10. In this example, the scores went through the overall score model to give a final score of 1.6 for the exemplary article.

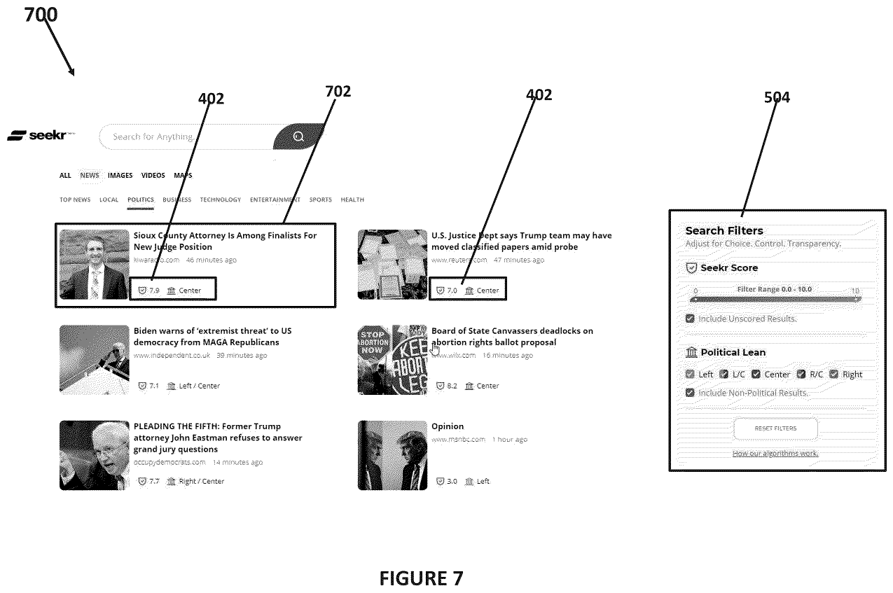

FIG. 7 illustrates an example of a politics search results 700 with the score 403 that includes a quality score and a political lean score. This user interface has the same search filters portion 504 that allows the user to adjust the filters. FIG. 8 illustrates an example of a detailed score user interface 800 for both a quality score and political lean score. Note that in each detailed score user interface (FIGS. 6 and 8), only the score factors present for the piece of content are shown in the user interface. For example, as shown in FIG. 8, the lack of site disclosure factor does not appear. However, each of the other factors are shown with the factor score to arrive at the quality score. In this example, since the piece of content is a political piece of content, a political lean factor 614 score is shown with that may be left, center and right and result in the political lean categories (left, left/center (L/C), center, right/center (R/C) and Right) as shown in FIG. 7.

### Scenario Examples

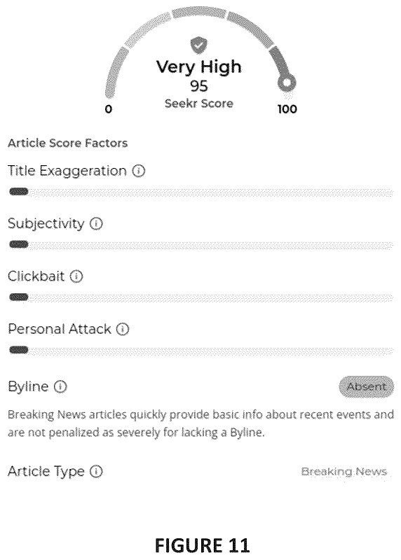

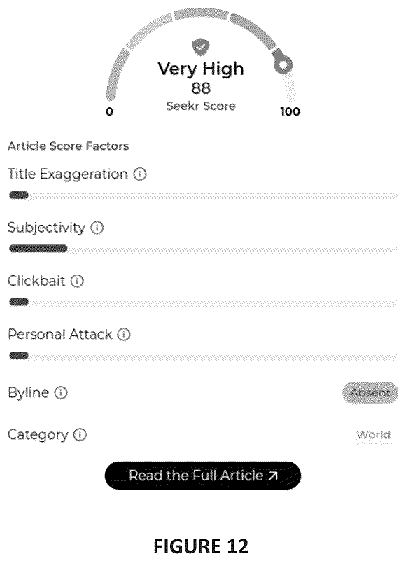

These examples illustrate how the disclosed quality scoring system and method performs a chain-of-thought process to adjust the overall quality score for a piece of content due to particular situations/scenarios for each specific piece of content. Note that this chain-of-thought process may be trained into the meta-learning machine learning model described above. The first set of examples are pieces of content (articles) that include breaking news and no byline. This set has three examples showing the different scores for each and how those scores are affected by each specific piece of content. The first article may be found at www.walb.com/2024/07/09/watch-live-ground-stop-issued-flights-departing-atlanta-airport/whose title is “Ground stop lifted for flights departing from Atlanta airport”, the second article may be found at www.wistv.com/2024/07/09/body-found-harbison-area-neighborhood-pond/whose title is “Body found in Harbison-area neighborhood pond” and the third article may be found at www.grantcountybeat.com/news/weather/85076-strong-thunderstorms-070924 whose title is “Strong thunderstorms 070924.” FIG. 11 is an example of a score user interface for the first piece of content with breaking news without a byline that has a very high overall score (95/100) but the user interface shows that there is no byline which did not affect the score. In this first article, the overall score is high since the title exaggeration, subjectivity, clickbait and personal attack score factors are low meaning that this first article does not contain any major violations of journalistic principle except that it is missing a named author (aka byline). However, the article does not receive a major score penalty because it is a breaking news article meant to provide readers with very basic and up-to-date information about an emerging story. FIG. 12 is an example of a score user interface for the second piece of content with breaking news without a byline that has a very high overall score (88/100) and the user interface shows that there is no byline which did not affect the score. In this second article, the overall score is lower that the first article since this article has more subjectivity (a higher subjectivity score factor that lowers the overall quality score), but the same level of title exaggeration, clickbait and personal attack score factors as the first article. This news article is missing a named author which would normally incur a heftier penalty due to lack of accountability. However, since this is a brief breaking news story that is only meant to provide notable and time-sensitive information, the penalty has been lessened. FIG. 13 is an example of a score user interface for the third piece of content with breaking news without a byline that has approximately the same overall score (84 vs. 88) as the second article. This article lacks any kind of writing attribution, but does not result in a major drop for the overall quality score because breaking news articles are meant to prioritize delivering basic and time-sensitive information rather than nuanced insights.

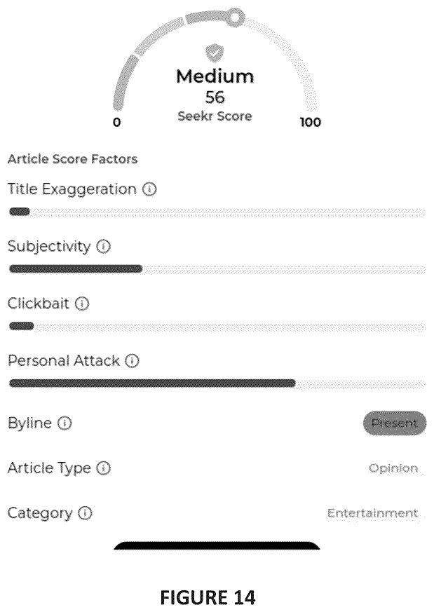

A second set of examples are pieces of content with ad hominem opinions. This set has three examples showing the different scores for each and how those scores are affected by each specific piece of content. FIG. 14 is an example of a score user interface for a first piece of content with ad hominem opinions. The first article may be found at timesofsandiego.com/opinion/2024/07/06/the-hatred-of-homelessness-hits-home-in-woodland-hills/ whose title is” Opinion: The Hatred of Homelessness Hits Home in Woodland Hills” and is a strange case because it is a column containing fiction, but the title and notes of the editor clearly tie this to a real story. For this first article, the overall score as shown in FIG. 14 is medium (56/100) and the article score factors show a small amount of title exaggeration and clickbait, but a larger amount of subjectivity and personal attacks resulting in the medium overall quality score. This article/piece of content frequently uses insulting and demeaning language such as “crazy white people” and “dirty old homeless broad”. Normally, this level of personal attack would result in a much larger score penalty.

However, since this is an opinion article, the penalty is somewhat lessened as audiences are more likely to expect strong statements based on personal beliefs.

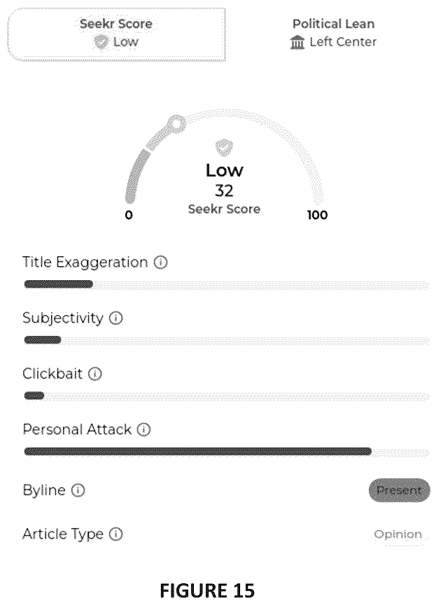

FIG. 15 is an example of a score user interface for a second piece of content with ad hominem opinions and the article may be found at www.thedailybeast.com/jon-stewart-theres-plenty-of-time-to-find-a-replacement-for-biden and whose title is “Jon Stewart: There's Plenty of Time to Find a Replacement for Biden”. For this second article, the overall score as shown in FIG. 15 is low (32/100) and the article score factors show more title exaggeration, less subjectivity, same level of clickbait and a significantly higher level of personal attack as compared to the first article resulting in the overall lower quality score of this second article. In more detail, this article contains some scathing remarks about political figures such as “Do you have any idea how thirsty Americans are for any hint of inspiration or leadership, and a release from this choice between a megalomaniac and a suffocating gerontocracy?” and “The debate was a shocking display of cognitive difficulty,”. This results in a very high personal attack rate. While the high personal attack rate does lead to a significant penalty to the overall document score, it would ordinarily be even greater if this were not an opinion-focused article.

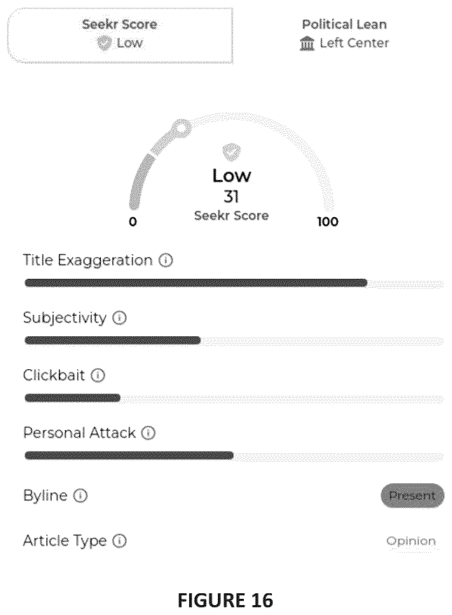

FIG. 16 is an example of a score user interface for a third piece of content with ad hominem opinions and the third article may be found at www.msnbc.com/opinion/msnbc-opinion/trump-biden-charlottesville-snopes-rcna160508 whose title is “Trump's Charlottesville statement was repugnant—no matter how you parse it”. For this third article, the overall quality score is low like the second article (31/100), but for different reasons. In particular, in this third article, it contains language that is both subjective and insulting such as name-calling (“gaslighter-in-chief Donald Trump”) and general attacks (calling Trump “morally bankrupt”). This causes a significant drop in the overall article score, but the penalty would have been even greater had this not been an opinion article. The quality scoring system and method score modulates the score penalty since opinion articles are written and read with the expectation that the author will state their personal beliefs.

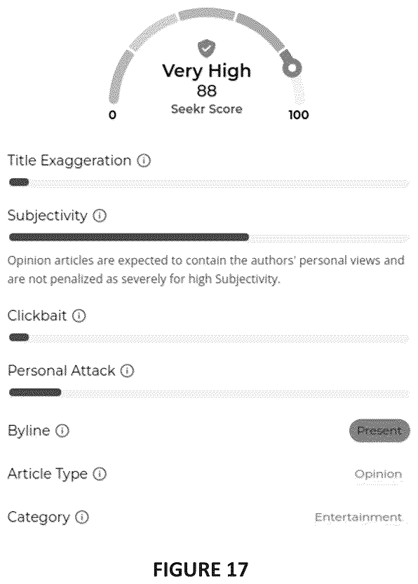

A third set of examples are pieces of content with subjective opinions. This set has three examples showing the different scores for each and how those scores are affected by each specific piece of content. FIG. 17 is an example of a score user interface for a first piece of content with a subjective opinion that may be found at www.chicagotribune.com/2024/07/09/column-new-theater-marquee-a-good-sign-for-downtown-aurora/ whose title is: “Column: New theater marquee a good sign for downtown Aurora”. For this first article with subjective opinions, it has a very high overall quality score (88/100) despite a high subjectivity score factor, but the other score factors are low. The AI generated reason as shown in the user interface is that opinion articles are expected to contain the author's personal views and are not penalized as severely for high subjectivity. This article contains a fairly large amount of subjective language in both the headline “New theater marquee a good sign for downtown Aurora” and the body (“For one thing, it will expand the Paramount's already impressive footprint and draw people to a beautiful section of the riverwalk”). However, since opinion articles are expected to contain the author's beliefs, subjectivity only has a minor penalty on the overall article score.

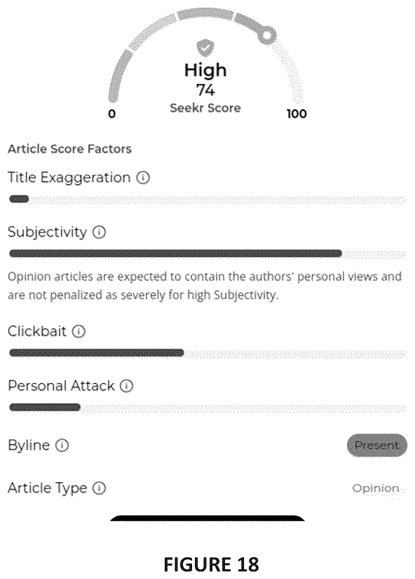

FIG. 18 is an example of a score user interface for a second piece of content with a subjective opinion wherein the article may be found at www.bostonglobe.com/2024/07/09/metro/why-cant-bpd-explain-eddy-chrispins-demotion/ whose title is “Why can't the Boston Police Department explain Eddy Chrispin's demotion?” For this second opinion article, it still has a high overall quality score (74/100), but lower than the first article since this article's headline displays some elements of clickbait by posing a claim (that the BPD cannot explain something) in the form of a question. It is also very subjective-offering opinions on key figures (“Sergeant Detective Eddy Chrispin is one of the most respected leaders in the Boston Police Department, and a strong voice for accountability and transparency.”) and using second person point-of-view language (“If you find that confusing, you are not alone.”). However, the relatively high subjectivity does not translate to a large score penalty in this instance because opinion articles are expected to be somewhat subjective. Instead, the relatively small penalty to the overall document score comes primarily from the presence of clickbait.

FIG. 19 is an example of a score user interface for a third piece of content with a subjective opinion that may be found at www.nytimes.com/2024/07/09/opinion/biden-election-trump.html and whose title is “Opinion | The Abyss Stares Back at Joe Biden”. This third opinion article displays a high level of subjectivity through stated opinions such as “The man elected to banish his self-deluded, deceptive, disrespected and destructive predecessor increasingly embodies those vices himself.” and “We have gone from Howard Baker's famous question about Richard Nixon—“What did the president know and when did he know it?”—to something much more pathetic: What does the president know and does he even remember it?”. Ordinarily, the level of subjectivity would incur a major penalty to the overall document quality score, but the penalty is relatively minor in this case since the article is an opinion piece. Instead, the observed penalty can be attributed mainly to personal attacks (see first quote) and the presence of clickbait and hyperbolic language in the story headline “The Abyss Stares Back at Joe Biden”.

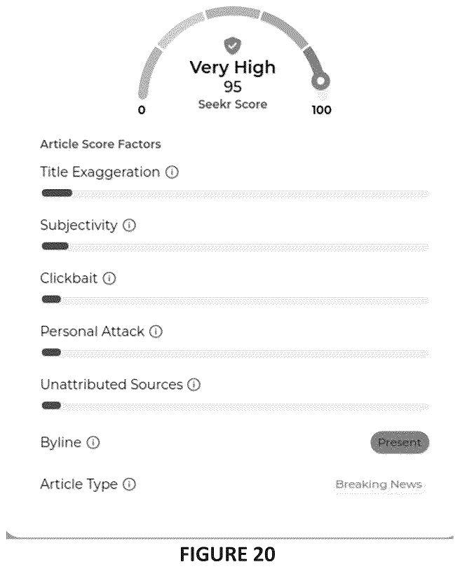

A fourth set of pieces of content are articles with source attribution or a lack of source attribution. This set has three examples showing the different scores for each and how those scores are affected by each specific piece of content. FIG. 20 is an example of a score user interface for a first piece of content with source attribution that may be found at www.kplctv.com/2024/07/09/swla-boil-advisories/ and whose title is “SWLA boil advisories.” A review of this article finds that the article cites it's source very clearly resulting in a high overall quality score (95/100) with low scores for title exaggeration, subjectivity, clickbait, personal attack since this article does not contain any major issues like clickbait, personal attacks, subjectivity, etc. It also clearly cites a named source for its claims and thus has a low unattributed sources score. The low unattributed sources score factor indicates that the unattributed sources detector (that may be a separate machine learning model) found the sources of the article clearly cited.

A second piece of content may be found at kotaku.com/alan-wake-2-night-springs-review-dlc-1851583087 and titled “Night Springs Is The Perfect Follow-Up To Alan Wake 2”. This article frequently uses subjective language (e.g. 1st and 2nd person POV), contains some potentially insulting language (e.g. “massive Yoko Taro sicko”), and does not cite sources for some of it's claims (e.g. “Thankfully more is coming. Lake House will be the second piece of DLC coming to the game this October and looks to pick up the threads of Alan Wake 2 more directly while also likely leading into Control 2.”). However, since this is a product review, the writing is expected to be subjective and there is not as strong of an expectation to cite named sources for everything.

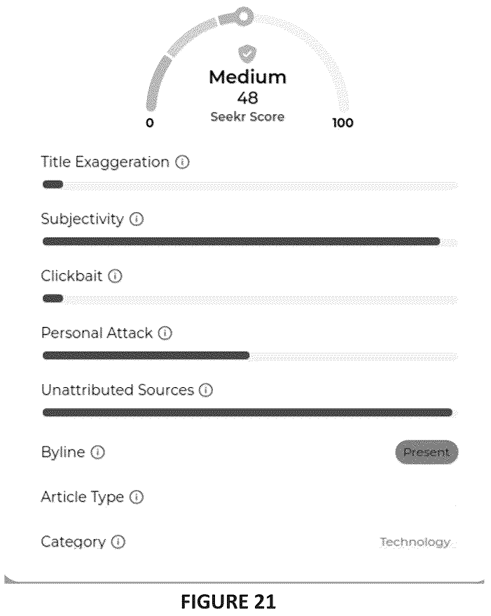

FIG. 21 is an example of a score user interface for a third piece of content with source attribution that may be found at sports.yahoo.com/best-worst-most-likely-scenarios-185333763.html and whose title is “Best, worst and most likely scenarios for Patriots WRs in 2024”. A review of this article finds that some sources are cited/linked, but many are just the author's opinion/prediction. For this third article that lacks source attribution, the overall quality score shown in FIG. 21 is medium (48/100) because the analysis article does not align very strongly with journalistic principles-the headline and content are highly subjective and are presumably based on the author's personal observations or interpretations (“Tough as hell, smart as a whip, a technician and a guy who can play beyond his age of 22 in terms of maturity and dependability.”, “He's a great energy player and is versatile as hell.”, “I've seen with my very own eyes each one make plays.”). There is also some language reminiscent of attacks such as “But the offense is so stagnant and unable to move the ball (think, “1, 2, 3, PUNT!) there are literally not enough plays in the game for anyone to get enough work.” and “Being bad is one thing. Being bad and boring? Worst-case scenario. And that, aside from the melodrama of the past two years, is what the team's been.”. A number of claims made in the article also do not have any cited references such as “The team, believing Smith-Schuster and Bourne's experience trumps development in the early part of the year, becomes overly reliant on those two and Osborn.”. These factors all lead to a lower score for this article.

Each of the above examples show that the relationship between the overall quality score of the article/piece of content and the factors/journalistic principles is different for different types of articles/pieces of content and is not simple combination of the score factors. The generation of the overall quality score aggregates these factor scores in a step-by-step, chain-of-thought process, that takes into account several things, such as the article category and type, degree of violation of the principles etc. that is a similar process for how a journalist thinks when assessing the quality of an article. As noted above, in this system and method, all of these process (generating each score factor and then generating the overall quality score) are performed using machine learning models that perform this step-by-step, chain of thought process.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers,. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “hercin,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

What is claimed is:

1. A system, comprising:
a computer system having a processor and a plurality of lines of instructions that are executed by the processor that is configured to:
retrieve a plurality of pieces of content;
generate a plurality of score factors for each piece of content of the plurality of pieces of content, each score factor having a score representing a degree of violation by each piece of content of a different document principle;
aggregate each score of the plurality of score factors to generate a quality score for each piece of content; and
store, for each piece of content, the quality score and the score for each of the score factors.

2. The system of claim 1 further comprising a search computer system having a processor and a plurality of lines of instructions that are executed by the processor that is configured to:
receive a search query having one or more query terms;
retrieve one or more pieces of content that match the one or more query terms;
retrieve the quality score and score of each of the plurality of score factors from the computer system; and
generate a search user interface having a summary of each of the matching one or more pieces of content, the quality score and the score of each of the plurality of score factors for each matching piece of content.

3. The system of claim 1, wherein the degree of violation of the principle is one of low, medium and high.

4. The system of claim 1, wherein the plurality of score factors are a source factor, an industry standard factor and a document type factor.

5. The system of claim 4, wherein the plurality of score factors are a byline factor, a title exaggeration factor, a subjectivity factor, a clickbait factor, a personal attack factor and a lack of site disclosure factor.

6. The system of claim 1, wherein the processor is further configured to crawl the plurality of pieces of content, ingest the crawled plurality of pieces of content and perform machine learning to generate the quality score for each piece of content.

7. The system of claim 2, wherein the processor of the search computer system is further configured to generate a search factors user interface that displays the plurality of score factors that together generate the quality score.

8. The system of claim 1, wherein each score factor is a journalistic principle.

9. The system of claim 8, wherein the plurality of score factors include a source factor, an industry standard factor, a document type factor, a byline factor, a title exaggeration factor, a subjectivity factor, a clickbait factor, a personal attack factor and a site disclosure factor.

10. The system of claim 2, wherein the processor of the search computer system is further configured to generate a filter user interface to adjust the quality scoring for each matching piece of content.

11. The system of claim 1, wherein each piece of content is a news piece of content.

12. The system of claim 1, wherein the processor is further configured to generate and store, for each piece of content, a political lean score indicating a political bias of the piece of content and generate the search user interface having a summary of each of the matching piece of content and the stored quality score and political lean score for each matching piece of content.

13. The system of claim 1, wherein the processor is further configured to generate the quality score for each piece of content using a transformer-based neural network.

14. A method, comprising:
retrieving, by a computer system having a processor and a plurality of lines of instructions that are executed by the processor, a plurality of pieces of content;
generating, by the computer system, a plurality of score factors for each piece of content of the plurality of pieces of content, each score factor having a score representing a degree of violation by each piece of content of a different document principle;
aggregating, by the computer system, each score of the plurality of score factors to generate a quality score for each piece of content; and
storing, by the computer system for each piece of content, the quality score and the score for each of the score factors.

15. The method of claim 14 further comprising receiving, at a search computer system having a processor and a plurality of lines of instructions that are executed by the processor, a search query having one or more query terms, retrieving, by the search computer system, one or more pieces of content that match the one or more query terms, retrieving, by the search computer system, the quality score and score of each of the plurality of score factors from the computer system and generating, by the search computer system, a search user interface having a summary of each of the matching one or more pieces of content, the quality score and the score of each of the plurality of score factors for each matching piece of content.

16. The method of claim B14 wherein the degree of violation of the principle is one of low, medium and high.

17. The method of claim 14, wherein the plurality of score factors are a source factor, an industry standard factor and a document type factor.

18. The method of claim 17, wherein the plurality of score factors are a byline factor, a title exaggeration factor, a subjectivity factor, a clickbait factor, a personal attack factor and a lack of site disclosure factor.

19. The method of claim 14 further comprising crawling, by the computer system, the plurality of pieces of content, ingesting, by the computer system, the crawled plurality of pieces of content and performing, by the computer system, machine learning to generate the quality score for each piece of content.

20. The method of claim 15 further comprising generating, by the search computer system, a search factors user interface that displays the plurality of score factors that together generate the quality score.

21. The method of claim 14, wherein each score factor is a journalistic principle.

22. The method of claim 21, wherein the plurality of score factors include a source factor, an industry standard factor, a document type factor, a byline factor, a title exaggeration factor, a subjectivity factor, a clickbait factor, a personal attack factor and a site disclosure factor.

23. The method of claim 15 further comprising generating, by the search computer system, a filter user interface to adjust the quality scoring for each matching piece of content.

24. The method of claim 14, wherein each piece of content is a news piece of content.

25. The method of claim 14 further comprising generating and storing, by he computer system for each piece of content, a political lean score indicating a political bias of the piece of content and wherein generating the search user interface further comprises generating the search user interface having a summary of each of the matching piece of content and the stored quality score and political lean score for each matching piece of content.

26. The method of claim 14, wherein the computer system generates the quality score for each piece of content using a transformer-based neural network.
